(19) United States
(12) Patent Application Publication
(10) Pub. No.: US 2003/0151907 A1
(43) Pub. Date: Aug. 14, 2003

(54) Illuminating device of instrument panel

(76) Inventor: Lance Chao, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/073,955

(22) Filed: Feb. 14, 2002

(51) Int. Cl. G01D 11/28

(52) U.S. Cl. 362/27; 362/26; 362/31; 362/482; 362/231

(57) ABSTRACT

An instrument panel includes a base on which indicators are movably mounted and a transparent cover positioned above the base. An illuminating device includes a board interposed between the base and the cover. The board defines a number of recesses in a bottom surface thereof for respectively and movably accommodating the indicators therein. The board defines a number of cavities in an end thereof for receiving illuminators, such as light emitting diodes, of different colors therein. The illuminators are connected to and controlled by a control circuit whereby the illuminators are selectively actuated to light the instrument panel with light of different colors by conducting light through the board. Scales of first unit system are formed by means of etching or other suitable manners on the board. Scales of second unit system are formed on the base. The base is provided with an additional light source. Power can be selectively supplied to either the control circuit for actuation of the illuminators or the additional light source. This allows the scales of the first and second unit systems to be selectively shown to observers so as to achieve switching between two unit systems.

### BACKGROUND OF THE INVENTION

1. Field of the Invention

The present invention relates generally to an instrument panel, and in particular to an instrument panel having an illuminating device capable to light the instrument panel with light of different colors and intensity of different levels.

2. The Related Art

Instrument panels are adopted in almost all kinds of measuring devices to show readings of measurement to an observer. Examples of the instrument panels include a vehicle instrument panel and a control panel of an automatic system. Most of the instrument panels that are currently available in the market are incorporated with an illuminating device comprising a light source, such as a light bulb, for illuminating the readings.

The conventional instrument panels, however, can provide light of constant intensity and color. It is in general impossible for general users to change the intensity and color of the light generated by the illuminating device of the instrument panel. In other words, the illuminating device that is employed in the instrument panels that are currently available only provides the function of illumination. No decorative or other user appealing function is provided.

Generally speaking, two unit systems, namely the metric system and the British unit system, are both commonly adopted worldwide but local regulation may stipulate different requirement of the unit systems. To accommodate the requirement of local regulations worldwide, most instrument panels are provided with two scales respectively corresponding to the two unit systems. The two scales are respectively printed or otherwise formed on the instrument panel and an observer can read the preferred one of the two scales. This, however, makes the surface patterning of an instrument panel complicated and may confuse the user.

### SUMMARY OF THE INVENTION

An object of the present invention is thus to provide an instrument panel that may selectively illuminate the readings with light of different colors and intensities.

Another object of the present invention is to provide an instrument panel having an illuminating device comprising a number of light sources of different colors that allow selection of display with different colors for being associated with different uses.

A further object of the present invention is to provide an instrument panel that allows switching between two different unit systems without substantial modification of the panel itself.

To achieve the above objects, in accordance with the present invention, there is provided an instrument panel comprising a base on which indicators are movably mounted and a transparent cover positioned above the base. An illuminating device comprises a board interposed between the base and the cover. The board defines a number of recesses in a bottom surface thereof for respectively and movably accommodating the indicators therein. The board defines a number of cavities in an end thereof for receiving illuminators, such as light emitting diodes, of different colors therein. The illuminators are connected to and controlled by a control circuit whereby the illuminators are selectively actuated to light the instrument panel with light of different colors by conducting light through the board. Scales of first unit system are formed by means of etching or other suitable manners on the board. Scales of second unit system are formed on the base. The base is provided with an additional light source. Power can be selectively supplied to either the control circuit for actuation of the illuminators or the additional light source. This allows the scales of the first and second unit systems to be selectively shown to observers so as to achieve switching between two unit systems.

### BRIEF DESCRIPTION OF THE DRAWINGS

The present invention will be apparent to those skilled in the art by reading the following description of a preferred embodiment thereof, with reference to the attached drawings, in which:

FIG. 1 is a schematic plan view of an instrument panel constructed in accordance with the present invention;

FIG. 2 is an exploded view of the instrument panel of the present invention; and

FIG. 3 is a cross-sectional view of the instrument panel of the present invention.

### DETAILED DESCRIPTION OF THE PREFERRED EMBODIMENT

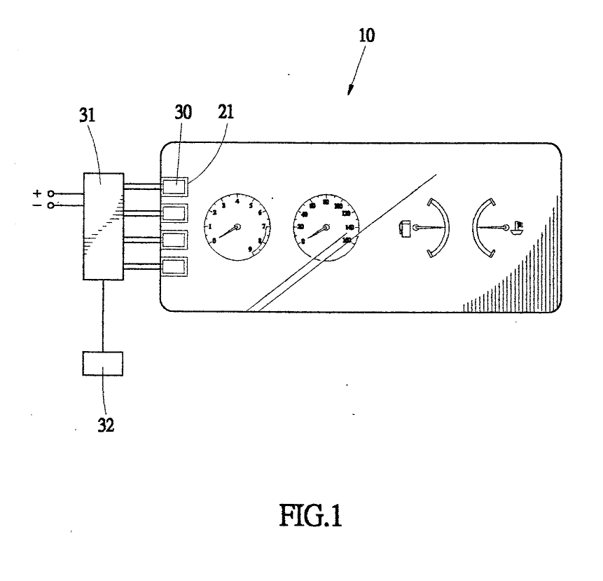

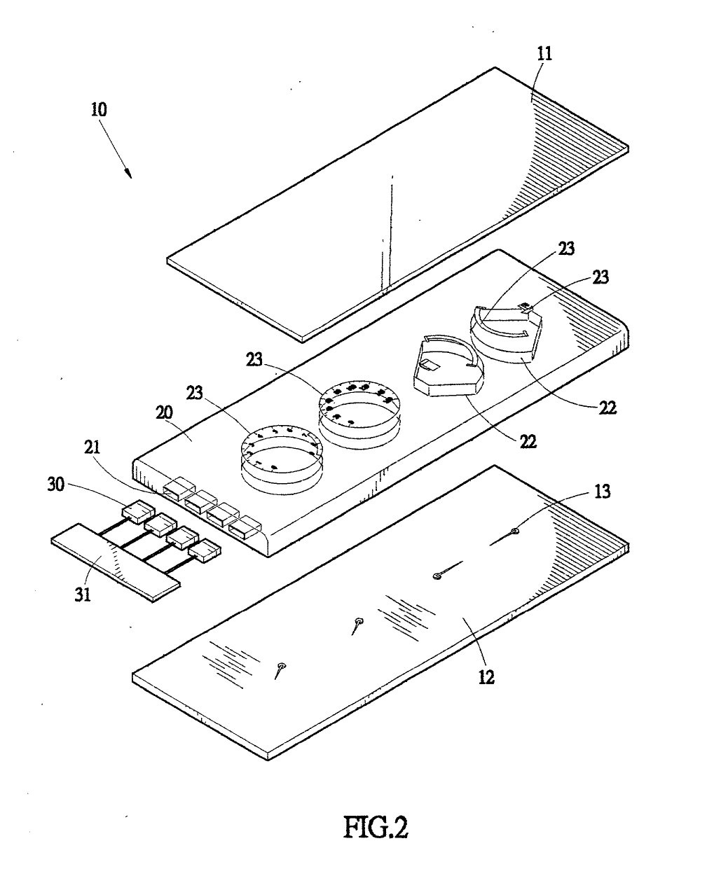

With reference to the drawings and in particular to FIGS. 1 and 2, an instrument panel constructed in accordance with the present invention, generally designated with reference numeral 10, comprises a base board 12 on which indicators 13 are movably mounted and a transparent cover board 11 positioned above the base board 12. An illuminating device (not labeled) comprises an intermediate board 20 interposed between the cover 11 and the base 12.

The intermediate board 20 defines a number of slots 21 in an end thereof for each receiving an illuminator 30, such as a light emitting diode (LED). The LEDs 30 that are received in the slots 21 give off lights of different colors. All the illuminators 30 are connected to and controlled by a control circuit 31 by means of a manual switch 32. The light from each of the illuminators 30 is conducted throughout the whole board 20.

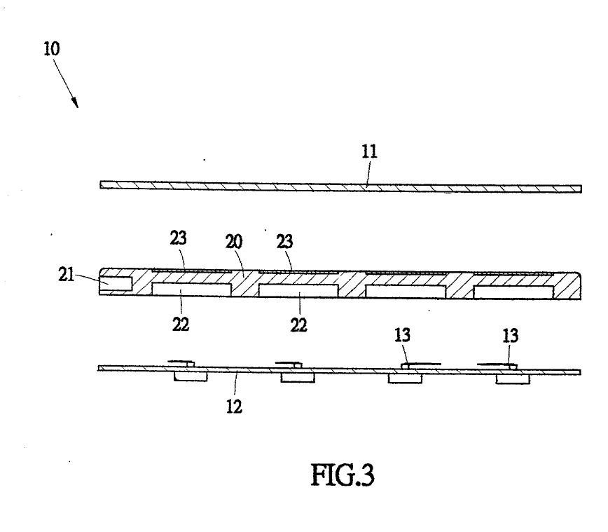

Also referring to FIG. 3, the intermediate board 20 also defines a number of recesses 22 corresponding in position and number to the indicators 13. The recesses 22 accommodate the indicators 13 and allow the movement of the indicators 13 therein. Patterns 23 are formed on a surface of the board 20 by means of, such as etching. The patterns 23 may include digitals, characters, figures and scales, but not limited thereto.

When any one of the illuminators 30 is lit under the control of the control circuit 31, the light emitted from the illuminator 30 is conducted through the whole board 20. The etch-formed patterns 23 also give off light from the illuminator 30. Different illuminators 30 give lights of different colors. There may be illuminators 30 of the same color whereby when two or more illuminators 30 of the same color are actuated at the same time, the brightness or intensity of the light given off is enhanced.

As shown in FIG. 1, the base board 12 is provided with no scale thereon. The scale is formed on the board 20 by means of etching or other suitable manners. However, it is possible to provide scales of different unit systems respectively on the base board 12 and the intermediate board 20. In this case, the base board 12 is in general a conventional instrument panel that has a conventional light source, such as a bulb, for lighting the instrument panel. The conventional light source and the control circuit 31 may be both connected to the same power source whereby the supply of power is switched between the conventional light source and the control circuit 31. When the power supplied to the conventional instrument panel is switched to the control circuit 31 and the illuminators 30, the scale that is formed on the base board 12 becomes less visible than the scale that is formed on the intermediate board 20. This allows switching between the two unit systems.

It is of course possible to provide two or more such intermediate boards stacked together between the cover 11 and the base board 12. This allows a user to have more flexibility in selecting combination of displaying patterns and colorful lights.

Although the present invention has been described with reference to the preferred embodiment with reference to the drawings thereof, it is apparent to those skilled in the art that a variety of modifications and changes may be made without departing from the scope of the present invention which is intended to be defined by the appended claims.

What is claimed is:

1. An instrument panel comprising:
a base on which an indicator is movably mounted; and
an illuminating device comprising:
a board positioned on the base, the board defining a recess movably accommodating the indicator, the board defining a cavity in an end thereof, patterns being formed on a surface of the board, and
an illuminator received in the cavity, the illuminator being connected to and controlled by a control circuit for emitting light, the light being conducted through substantially the whole board and given off through the pattern.

2. The instrument panel as claimed in claim 1, wherein the board defines two cavities for respectively receiving two illuminators.

3. The instrument panel as claimed in claim 2, wherein the illuminators give off lights of different colors.

4. The instrument panel as claimed in claim 1, wherein the illuminator comprises a light emitting diode.

5. The instrument panel as claimed in claim 1, wherein the base is provided with scale of a first unit system and the board is provided with scale of a second unit system that is different from the first unit system, and wherein the base comprises an additional illuminating system, power supply being switchable between the additional illuminating system and the illuminating device for selectively actuating the additional illuminating system and the illuminating device.
